(19) United States
(12) Patent Application Publication
(10) Pub. No.: US 2005/0147786 A1
(43) Pub. Date: Jul. 7, 2005

(54) Carpet construction

(76) Inventors: John C. Clark, White Bear Lake, MN (US); Malcolm B. Burleigh, St. Paul, MN (US); William P. Jones, St. Paul, MN (US)

Correspondence Address: 3M INNOVATIVE PROPERTIES COMPANY, PO BOX 33427, ST. PAUL, MN, 55133-3427, US

(21) Appl. No.: 10/748,026

(22) Filed: Dec. 30, 2003

(51) Int. Cl. B32B 33/00; D05C 17/02

(52) U.S. Cl. 428/95; 428/97; 428/96

(57) ABSTRACT

A carpet which comprises: a) a pile comprising a plurality of face yarns; b) a primary backing having two major surfaces, i.e., a face surface and a back surface, the face yarns being secured to the primary backing and extending from the face, surface thereof; and c) an impermeable hydrophobic barrier bonded to the primary backing. Substantially the entire surface of the portion of the face yarn which is not encased within at least one of the barrier or the backing is hydrophobic.

### TECHNICAL FIELD

The present invention relates a new carpet construction. More particularly, the present invention relates to carpet providing improved stain resistance and stain removal and superior resistance to odor.

### BACKGROUND OF THE INVENTION

Tufted carpet is widely used today in the United States and abroad. Such carpet is produced by tufting machines which are essentially multi-needled sewing machines. The tufting machines push or, more specifically, sew the face yarns of the carpet (also referred to as pile yarns) through a primary backing, forming loops in the face yarns. The machines also hold the face yarns in place while the needles are withdrawn. The resulting loops formed by the face yarns are then either released to form loop-pile, tufted carpet, or cut to form cut-pile, tufted carpet.

A secondary backing is often attached to the rear side of the primary backing, i.e., the side opposite the side from which the face yarns protrude to hold the tufted face yarn in place. Secondary backings are typically attached to the primary backing by a latex or other binding adhesive applied to the rear side of the primary backing. In addition to securing the pile yarns to the carpet, the combination of the secondary backing and the adhesive binder impart necessary rigidity and dimensional stability to the carpet, allowing it lay flat and resist buckling or travel under use.

It is widely known to apply hydrophobic treatments to carpet tuft fibers to impart water-repellent characteristics thereto. Known treatments have included fluorochemical-based and non-fluorochemical based materials. In some instances the treatments are applied as surface treatments and coatings to finished fibers or even carpet constructions, in other instances the repellent properties are achieved through incorporation of selected materials into the material from which the fibers are made. However, even when such treatments are employed, the resultant carpet still does not provide desired resistance to the effects of spills. Liquids spilled on such carpets will tend to penetrate the pile layer of the carpet and enter the primary backing and other lower layers in the carpet, and even penetrate therethrough to the flooring surface below the carpet.

While such known repellent treatments can impart desired repellent properties to the carpet tuft, they have not provided fully desired performance. When liquids are spilled onto carpet surfaces, typically at least some portion will penetrate through the tuft zone, into and through the carpet backing. The penetrating liquid will then migrate laterally within the carpet construction or between the carpet and underlying flooring. Once liquid has penetrated into the carpet it is difficult to remove and commonly leads to visible discoloration of the carpet and may lead to odor formation. In the case of carpet with repellent-treated tufts, the problem may be exacerbated because the kinetic energy of the spill and gravity tends to cause the liquid to penetrate through the tuft and then the repellent properties of the tuft then tend to inhibit movement of the liquid up through the carpet tuft, e.g., when blotting of the spill is attempted, thereby causing the liquid to migrate further downward into the carpet and laterally.

U.S. Pat. No. 4,643,930 (Ucci) discloses a carpet comprising stain resistant pile fibers and a backing that is substantially impervious to water.

U.S. Pat. No. 5,612,113 (Irwin) discloses a carpet comprising a fluid barrier bonded either to the rear of the primary backing or to the rear of the secondary backing

The need exists for carpet which provides improved spill control and resistance to staining and odor formation.

### SUMMARY OF INVENTION

The present invention provides carpet that provides superior spill control and resistance to staining and odor formation.

In brief summary carpet of the invention comprises:
a) a pile comprising a plurality of face yarns;
b) a primary backing having two major surfaces, i.e., a face surface and a back surface, the face yarns being secured to the primary backing and extending from the face surface thereof; and
c) an impermeable hydrophobic barrier bonded to the primary backing. Substantially the entire surface of the portion of the face yarn which is not encased within at least one of the barrier or the backing is hydrophobic.

### DETAILED DISCUSSION OF ILLUSTRATIVE EMBODIMENTS OF THE INVENTION

As used herein, the term “carpet” refers inclusively to all forms of tufted, woven, and needled types of carpet in either broadloom or tiled configuration.

In brief summary carpet of the invention comprises:
a) a pile comprising a plurality of face yarns;
b) a primary backing having two major surfaces, the face yarns being secured to the primary backing and extending from a first major surface thereof; and
c) an impermeable hydrophobic barrier bonded to the primary backing. Substantially the entire surface of the portion of the face yarn which is not encased within at least one of the barrier or the backing is hydrophobic.

As with carpet in general, a typical carpet of the invention includes a plurality of face yarns which are typically tufted, woven or needle punched into and through a primary backing fabric, providing loops which are locked into the primary backing. These, in turn, are more securely held in place by a conventional latex or binding adhesive or other secondary backing applied to the rear surface of the primary backing.

The face yarns may be made from any material known in the art suitable for use as face yarns and are preferably made from polymers selected from the group consisting of polyolefins; polyamides; polyesters, polyethylene terephthalate (PET) and polytrimethylene terephthalate (PTT), and mixtures thereof. Most preferred are polypropylene, polyester and nylon. Fibers of other composition, including natural fibers, may be used if desired.

The face yarns may be prepared by any conventional means known in the art. Preferably, conventional equipment and methods are employed to make spun yarns or bulked continuous filament yarns comprising a plurality of polymeric fibers produced by conventional extrusion methods with conventional equipment. The term face yarns is thus intended to include all forms of yarn that can be employed to manufacture carpet whether spun yarn, bulk continuous filament yarn or other forms of yarn.

The primary backing fabric may be produced using any of several known accepted methods. Typically, the primary backing, as well as the secondary backing if any, are made from polyamides and polyolefins, particularly polypropylene. As is known, primary and second backing fabrics are prepared from fibers, typically synthetic fibers, which have come to replace natural or staple fibers. Nevertheless, fibrous components can be derived from natural fibers as well as synthetic and synthetic materials can be derived from virgin as well as recycled materials and thus, practice of the present invention is intended to include all forms of fibers in the manufacture (weaving) of primary and secondary backing fabrics and selection thereof is not critical to practice.

With respect to the adhesive binders, typical materials utilized include styrene-butadiene rubbers (SBR's), PVC, EVA, polyesters, polyurethanes, polyolefins, emulsified polymers and the like. Accordingly, practice of the present invention includes all known face yarns and backing materials, as well as adhesive binders, none of which constitute a limitation to the practice. Moreover, other methods for joining the primary and secondary backing members together include extrusion coating, melt blown, thermal bonding including ultrasonic, infrared, microwave, radio frequency and the like. Any adhesives are preferably insoluble to, and more preferably impermeable to, liquids encountered in residential and commercial establishments, e.g., water, alcohol-based beverages, urine, etc.

In accordance with the present invention an impermeable hydrophobic barrier is applied to either the rear face of the primary backing or the rear face of secondary backing of carpet to achieve a fluid barrier so that liquids spilled onto the carpet do not penetrate through the carpet onto the sub-surface beneath the carpet. It is typically preferred that the barrier is bonded to the rear surface of the primary backing and the secondary backing, if any, bonded to the rear surface of the barrier such that the barrier protects the secondary backing from contact with any spilled liquids that might penetrate the pile and primary backing. By impermeable, it is meant that the layer is impervious to spills normally encountered in residential and commercial establishments, such as water and alcohol-based beverages, and urine.

Conventional hot melt adhesives, or other non-aqueous adhesives such as polyurethanes which sometimes are used instead of latex to bind a secondary backing to the primary backing for obtaining a stronger bond than latex, may be utilized as the adhesive, or other adhesives which do not contain solvents or water may utilized. The adhesive may act as a precoating agent for the secondary backing as well as the adhesive for lamination of the film wherein the film is laminated to the primary or secondary backing, or the adhesive may be the bonding agent for the film to the secondary backing, which may be a foam cushion.

Illustrative examples of materials from which the barrier may be formed include polyethylene, polypropylene, polyurethane, polyester, polyvinylchloride (PVC), combinations of these and similar thermoplastic materials which may be surface treated and may be composite structures formed from laminates of these fibers with non-woven or woven fibers and either with or without reinforcing fibers. The film may vary in thickness, e.g., typically from approximately 1 mil to 5 mils, such that the overall carpet construction retains desired flexibility. In embodiments of broadloom carpet, it is of course necessary that the carpet be sufficiently flexible to be rolled up during fabrication, transport, delivery, and installation. In embodiments of the invention in tile form, it will typically be acceptable for the carpet to be relatively stiff and relatively inflexible.

For achieving the fluid barrier on conventional residential carpet, an unsupported film bonded to the secondary backing is sufficient to provide the fluid barrier since residential carpet is normally laid over a cushion, stretched and attached to the floor by tacks or tackless mounting strips, i.e., residential carpet is not glued to the floor. In commercial use, where the carpet may be glued directly to the floor, a film having a fiberous surface on the side facing the floor may be preferred. This permits the use of conventional carpet-to-floor adhesives. The laminated film may also have an additional layer of polyester fiber or glass fiber to increase the dimensional stability of the carpet.

The fluid barrier may be applied to the carpet with non-aqueous adhesives other than hot melt adhesives. Such adhesives preferably do not contain solvents or water which would require additional processing and difficulties. Polyurethane is one such conventional adhesive known in the bonding art. Others are polyvinylchloride, polyvinyl acetate, epoxies and the like. Such adhesives may be coated conventionally onto the back of the secondary backing of carpet or directly to the film and cured with or without heat, dependent upon the particular composition of the adhesive. Thus, the process is similar to that used for the hot melt adhesives but utilizes appropriate adhesive mixing equipment and processing well known in the art. These adhesives may also be applied to the primary backing to act as a pre-coat for the secondary backing and as an adhesive for the film. Where a foam cushion is to be applied to the carpet rather than a conventional woven secondary backing, the fluid barrier is applied between the primary backing and the foam and bonded therebetween. In most instances of this type, it is preferable to use a film that comprises a non-woven or woven fabric on both sides to gain a maximum bond. However, corona treatment on one side of the film may be sufficient to be bondable to the backing. It is preferred that when a pre-coat and a foam is to be applied to the primary backing, the film is to be layered onto the surface of the pre-coated carpet in the production line prior to the application of the foam.

Substantially the entire surface of the portion of the face yarn which is not encased within at least one of the barrier or the backing is hydrophobic. In some embodiments, this is achieved by using as face yarn fibers which are inherently hydrophobic (due to inherent properties of the fiber material or incorporation of selected additives therein) or fibers which have been treated, e.g., with a surface treatment or coating to impart the desired hydrophobic properties thereto. In some other embodiments, the face yarn fibers may be treated after attachment to the primary backing. This may be done with any of a number of known treatment processes and compositions. An advantage of this approach is that to face surface of the primary backing can also be simultaneously treated to impart desired hydrophobicity.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

### EXAMPLES

The invention will now be further explained with the following illustrative examples.

Test Methods

The following test methods were used.

Splash Test

One foot square pieces of carpet were spilled upon (to pile side) from a height of 36 inches (91 cm) with 50.0 g quantities of solutions of red dye No. 40 (pH adjusted to 3.0 with citric acid; 70 mg red dye No. 40 per liter of water). Under each piece of carpet was placed 8 sheets of paper towels (Kimberly Clark) that had been previously weighed (wᵢ). After the spill, the towels were reweighed (wf) to determine the weight gain (w_{diff}) from liquid penetrating through the carpet samples, calculated as:
w_{f}−wᵢ=w_{diff}
A lower number indicates that the carpet acts as a better barrier to liquid spill penetration.

Wicking Test

One foot square pieces of carpet were stained by applying 25.0 g of solutions of red dye No. 40 (pH adjusted to 3.0 with citric acid; 70 mg red dye No. 40 per liter of water) directly to the pile side of the carpet. The solution is poured into a 2.5 inch (6.4 cm) diameter ring to limit the spot size. The liquid is then pressed into the carpet. After the sample had dried, the carpet is cut in half through the stain and the progress of the red dye No. 40 solution is observed. The lateral spreading of the stain in either the carpet fiber or the backing is determined by measuring the diameter of the flow pattern in cross section cut of the carpet after staining.

Carpet Manufacture

The carpet materials used in the examples were manufactured as follows.

Co-Application Finish

Unbacked carpet, dyed, steamed, and vacuum extracted to ca. 40% to 60% wet pick-up (WPU), is passed vertically, from top to bottom, through a liquid bath containing water, finish chemicals (such as stainblocker and fluorochemical), and auxiliary chemicals. The carpet exits the bottom of the bath through a slot between two hollow rubber seals that are inflated to provide a flexible seal against the moving carpet and to squeeze some of the excess liquor from the carpet as it passes through. The amount of liquor left in the carpet (typically 200%-400%) is determined by the construction of the carpet and the pressure in the seals. The concentrations of the finish chemicals and auxiliaries are adjusted to match the “FLEXNIP” WPU. For exhaust application of stainblocker, or exhaust co-application of stainblocker and fluorochemical, the bath contained the equivalent of 1.9 g/l of MgSO₄, and was adjusted to a pH of about 2, using a commercially available acid, such as Sulfamic Acid, or Autoacid A-80 (Peach State Labs, Rome, Ga.). The carpet is passed through a steam chamber to fix the finish to the fiber. It is then rinsed and extracted to remove as much water as possible, typically to less than 30% WPU, before additional finish application, drying and backing.

If a fluorochemical treatment is spray-applied to stainblocked carpet in a separate step, the application is usually done immediately following the final stainblocker rinse and extraction steps, and immediately before drying and backing. The wet carpet passes beneath a manifold array of spray tips which are arranged so as to provide complete and even coverage over the entire width of the carpet. An aqueous dispersion of fluorochemical is sprayed at low wet pick-up (typically less than 10% WPU) onto the surface of the carpet. The concentration of the fluorochemical is adjusted to achieve the desired application level depending on wet pick-up.

The secondary backing may be applied to the carpet as part of the same process, or the carpet may be dried and the secondary backing may be applied in a separate operation. In either case, the carpet is passed through a continuous bank of ovens until it is dry. The temperature of the ovens is usually in excess of 250° F. The speed of the carpet through the ovens is controlled so that the carpet is just dry as it exits the ovens. If the backing is applied in a separate step, the carpet and finish experiences a second high temperature treatment.

The secondary carpet backing, sometimes referred to as an “action back”, is typically a layer of latex rubber, applied as a foam, together with a polypropylene mesh or scrim which reinforces the latex and provides dimensional stability to the finished carpet. The latex/scrim layer provides a mechanically robust base for the carpet and adheres to the yarn tufts locking them into place. The latex rubber is usually extended by blending in ground calcium carbonate (limestone). Depending on several considerations, more than 50% of the applied latex layer may be limestone. The final backing is typically hydrophilic and internally porous. Although the secondary backing may appear to the unaided eye to be substantially continuous, it typically contains numerous channels which penetrate the entire thickness of the backing.

Co-Application of Stainblocker and Fluorochemical.

The carpet sample was pre-wet, steamed, rinsed, extracted, and placed, fiber side down, in a tray containing the treating composition. The treating composition contained sufficient stainblocking material (and fluorochemical, if it was to be co-applied with the stainblocker) to give the desired percent solids on carpet (%SOC), and was prepared by dissolving or dispersing the material(s) and the desired amount of salt (MgSO₄) in water and adjusting the pH to a value of approximately 2 (unless otherwise specified) using 10% aqueous Sulfamic Acid The weight of the aqueous treating solution in the tray was approximately 4 times the weight of the carpet sample. The carpet sample was manipulated, by hand, to evenly distribute the treating solution throughout the carpet to a treatment level of 400% WPU. The carpet was then steamed for 2 min. in saturated steam, rinsed, centrifugally extracted.

If the treatment was a co-application of stainblocker and fluorochemical, the carpet was immediately placed in an oven where it was dried/cured for 25 min., at 250° F. If the fluorochemical was to be applied in a separate spray application, the stainblocked carpet was sealed in a plastic bag to maintain final moisture level until the fluorochemical was applied.

Spray Application of Fluorochemicals; No. 1

The aqueous treating compositions containing the fluorochemicals were applied by low wet pick-up spray (typically 15%-20%) onto previously stainblocked carpet that had been left damp. Fluorochemical concentrations in the bath were adjusted to achieve the desired application rate, depending on wet pick-up. After the spray application, the samples were dried in an oven at 250° F. for 25 min.

Carpet samples used for laboratory applications were standard production, 26 oz./sq. yd., Nylon 6,6 carpet, purchased dyed, but untreated and unbacked, from Shaw, Inc., Dalton, Ga.

### Comparative Example C1

Spray Application #2; Fluorochemical with Standard Backing

Dyed, unbacked nylon carpet was treated with FC-661 stainblocker (available from 3M Company, St. Paul, Minn.) at the rate of 1.75% product based on fiber weight (POF) by a mill “FLEXNIP” application, at approximately 300% WPU, steamed for about 2 min., rinsed, and vacuum extracted to a final moisture level of less than 30%. FX-1367 (manufactured by 3M Company) was applied to a level of approximately 500 ppm F, based on weight of fiber, was applied by low wet pick-up spray, as described above. A secondary backing of filled latex and scrim was applied in the usual fashion, and the carpet was passed through an oven at >250° F. until the carpet was dried and the latex was cured.

### Comparative Example C2

Spray Application #2; Fluorochemical with Hydrophobic, Impermeable Backing.

Dyed, unbacked Nylon carpet was prepared by applying FC-661, at 1.75%, using the laboratory simulated “FLEXNIP”, and FX-1367 at 500 ppm F by laboratory spray at 15% WPU, followed by drying in an oven at 250° F. for 25 min. The carpet was backed with a hydrophobic and impermeable backing by adhering to the carpet a tightly-woven fabric with a hot-melt adhesive (BS521 Satin faced iron-on material, available from Brown Printing Co., Dalton, Ga.).

### Comparative Example C3

Co-Application of Stainblocker and Fluorochemical with Standard Backing

FC-661 and FC-1395 (available from 3M Company, St. Paul, Minn.) were co-applied to dyed, steamed, and rinsed, unbacked, Nylon carpet in a mill “FLEXNIP” application. 1.75% stainblocker and 500 ppm F Fluorochemical were applied in a 350% WPU “FLEXNIP” application from a pH 2.0 bath (adjusted with sulfamic acid) with a MgSO₄ concentration of 1.9 g/l, as described above. The treated carpet was backed with a standard backing of limestone-filled latex and polypropylene scrim, then passed through an oven at >250° F., until the latex was cured and the carpet was dry.

### Example 1

Co-Application of Stainblocker and Fluorochemical with Hydrophobic, Impermeable Backing.

Pre-dyed, unbacked, untreated carpet with FC-661 and FC-1395 in a laboratory co-application. 1.75% FC-661, and 500 ppm F of FC-1395 were co-applied to carpet samples by laboratory “FLEXNIP”, at 350% WPU from a pH 2.0 bath, containing 1.9 g/l of MgSO₄. The carpet samples were dried at 250° F. for 25 min. The carpet was backed with a hydrophobic and impermeable backing by adhering to the carpet a tightly-woven fabric with a hot-melt adhesive.

The following results were obtained.

| | Splash Test* | Wicking Test* |
|---|---|---|
| Example | (W_{diff}, g) | inches (cm) |
| C1 | 12 | 9.3 (23.6) |
| C2 | 0 | 7.8 (19.8) |
| C3 | 10 | 8.3 (21.1) |
| 1 | 0 | 3.8 (9.5) |

*average of 2 runs

1. A carpet comprising:
a) pile comprising a plurality of face yarns;
b) a primary backing having a face surface and a back surface, said face yarns being secured to said primary backing and extending from said face surface thereof; and
c) an impermeable hydrophobic barrier bonded to said primary backing, wherein substantially the entire surface of the portion of said face yarn which is not encased within at least one of said barrier or said backing is hydrophobic.

2. The carpet of claim 1 wherein said face yarn is selected from the group consisting of polyolefins, polyamides, polyesters, polyethylene terephthalate (PET) and polytrimethylene terephthalate (PTT), natural fibers, and mixtures thereof.

3. The carpet of claim 1 wherein said primary backing is selected from the group consisting of polyolefins, polyamides, natural fibers, and mixtures thereof.

4. The carpet of claim 3 wherein said primary backing comprises polypropylene fibers.

5. The carpet of claim 1 wherein said barrier is bonded to the back surface of said primary backing with an adhesive.

6. The carpet of claim 1 wherein barrier self-adheres directly to said primary backing.

7. The carpet of claim 1 wherein said barrier impregnates at least a portion of said primary backing.

8. The carpet of claim 1 wherein said barrier is in direct contact with said face yarn.

9. The carpet of claim 1 wherein said exposed portion of said face yarn is coated with a repellent/stainblocker.

10. The carpet of claim 1 further comprising a secondary backing.

11. The carpet of claim 10 wherein said secondary backing is bonded directly to the back face of said primary backing.

12. The carpet of claim 10 wherein said secondary backing is intermediate to said primary backing and said secondary backing.
